(19) United States
(12) Patent Application Publication
(10) Pub. No.: US 2026/0323548 A1
(43) Pub. Date: Oct. 15, 2026

(54) TECHNIQUES FOR SYNCHRONIZATION SIGNAL BLOCK (SSB) CONFIGURATION FOR ON-DEMAND SYSTEM INFORMATION

(71) Applicant: QUALCOMM Incorporated, San Diego, CA (US)

(72) Inventor: Hung Dinh LY, San Diego, CA (US)

(21) Appl. No.: 19/175,897

(22) Filed: Apr. 10, 2025

(51) Int. Cl. H04W 56/00; H04W 52/36; H04W 74/0833

(52) U.S. Cl. CPC H04W 56/0015; H04W 52/36; H04W 74/0833

(57) ABSTRACT

Example implementations include a method, apparatus and computer-readable medium of communications at a user equipment (UE). The UE may receive, from a cell, a configuration message for an on-demand system information (OD-SI) procedure configuration associated with a synchronization signal block (SSB). The UE may further transmit a signal to request an SI to the cell according to the configuration message. The UE may also receive the SI from the cell at least based on the configuration message.

### TECHNICAL FIELD

Aspects of the present disclosure relate generally to wireless communication systems, and more particularly, to synchronization signal block (SSB) configuration for on-demand system information.

### DESCRIPTION OF RELATED TECHNOLOGY

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as NR) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

For example, the existing New Radio (NR) framework may support flexible system information configurations. However, with more flexibility come increased implementation complexity at least at the signaling level. Thus, improvements in wireless communication with respect to system information configurations may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communications. The method may include receiving, from a cell, a configuration message for an on-demand system information (OD-SI) procedure configuration associated with a synchronization signal block (SSB). The method may further include transmitting a signal to request an SI to the cell according to the configuration message. The method may further include receiving the SI from the cell at least based on the configuration message.

Another example aspect includes an apparatus for wireless communications comprising a transceiver having a plurality of antennas, one or more memories, and one or more processors coupled to at least one of the one or more memories. The one or more processors may be configured to receive, from a cell, a configuration message for an OD-SI procedure configuration associated with a SSB. The one or more processors may be further configured to transmit a signal to request an SI to the cell according to the configuration message. The one or more processors may be further configured to receive the SI from the cell at least based on the configuration message.

Another example aspect includes an apparatus for wireless communications at a UE, comprising means for receiving, from a cell, a configuration message for an OD-SI procedure configuration associated with a SSB. The apparatus may further include means for transmitting a signal to request an SI to the cell according to the configuration message. The apparatus may further include means for receiving the SI from the cell at least based on the configuration message.

Another example aspect includes a computer-readable medium comprising stored instructions for wireless communications, the instructions are executable by one or more processors, individually or in combination, to receive, from a cell, a configuration message for an OD-SI procedure configuration associated with a SSB. The computer-readable medium further comprises instructions that are executable by one or more processors, individually or in combination, to transmit a signal to request an SI to the cell according to the configuration message. The computer-readable medium further comprises instructions that are executable by one or more processors, individually or in combination, to receive the SI from the cell at least based on the configuration message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various implementations of the present disclosure;

FIG. 2 is a block diagram illustrating an example of a network entity (also referred to as a base station or gNB), in accordance with various implementations of the present disclosure;

FIG. 3 is a block diagram illustrating an example of a user equipment (UE), in accordance with various implementations of the present disclosure;

FIG. 4 is a diagram illustrating an example disaggregated base station architecture, in accordance with various implementations of the present disclosure;

FIG. 5 is a conceptual diagram of an on-demand system information block one (SIB1) procedure, in accordance with various implementations of the present disclosure;

FIG. 6 is a flowchart of an example of a method of wireless communications at a UE, in accordance with various implementations of the present disclosure; and

FIG. 7 is a block diagram illustrating an example of a MIMO communication system including a base station and a UE, in accordance with various implementations of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to synchronization signal block (SSB) configurations for on-demand system information (OD-SI). The SSB may facilitate the initial access and synchronization of UE with the network. The SSB may contain essential signals and information that help UEs identify and connect to a cell. An SSB may be formed of a primary synchronization signal (PSS), a secondary synchronization signal (SSS), and a physical broadcast channel (PBCH), which may carry the master information block (MIB), which is also referred to as synchronization signal/PBCH block or SS/PBCH block.

In some wireless communication networks, OD-SI may include or otherwise correspond to on-demand system information block one (OD-SIB1) or on-demand other system information (OSI) may trigger based on demand, the transmission of SI by a network entity, i.e., by a user equipment (UE), rather than being broadcast periodically. This means that the network may send SI after receiving a request from a UE, rather than transmitting SI at regular intervals. By transmitting SI only when requested, networks can reduce unnecessary signaling, efficiently use radio resources or go into deeper sleep to reduce the energy consumption, which is particularly beneficial in scenarios with low device activity. In environments where device activity may be sporadic, on-demand SI may help optimize network operations and reduce unnecessary load.

SIB1 may provide vital parameters that allow a UE to access a network cell. This may include information about the cell's identity and configuration, which is used for the device to establish a connection. SIB1 may include a public land mobile network (PLMN) identity, scheduling information, system time, access barring information, and radio resource configuration. SIB1 may be one of the first pieces of information a UE receives when attempting to connect to a wireless communication network, and ensures that UEs can correctly interpret and use the network's configuration parameters, facilitating seamless connectivity.

In some wireless communication networks, an OD-SI procedure for idle or inactive or connected mode UEs with a network energy savings (NES) cell may have a number of implementation complexities. A NES cell may correspond to a cell within a wireless communication network that is configured to implement energy-saving measures. The configuration message for transmitting the signal to request SI may be large, which is not feasible to include in MIB. As such, the present implementations provide signaling optimizations for parameters related to SSB for uplink wake-up signal (WUS) transmission so that the signaling overhead can be included in a MIB.

Particular implementations of the subject matter described in this disclosure can be implemented to realize one or more of the following potential advantages. The disclosed techniques can improve UE operation such that if the SIB1 is transmitted with a long periodicity, e.g., 160 ms, the latency to acquire SIB1 may be long. On the other hand, with OD-SI, the UE can obtain SI whenever it needs with a shorter SI acquisition latency.

As such, the implementations set forth herein relate to a UE that receives an OD-SI procedure configuration indication from a NES cell. The UE may also transmit a physical random access channel (PRACH) in a PRACH resource or a PRACH occasion as an uplink WUS to request a SI to the NES cell. The UE may then receive the SI from the NES cell.

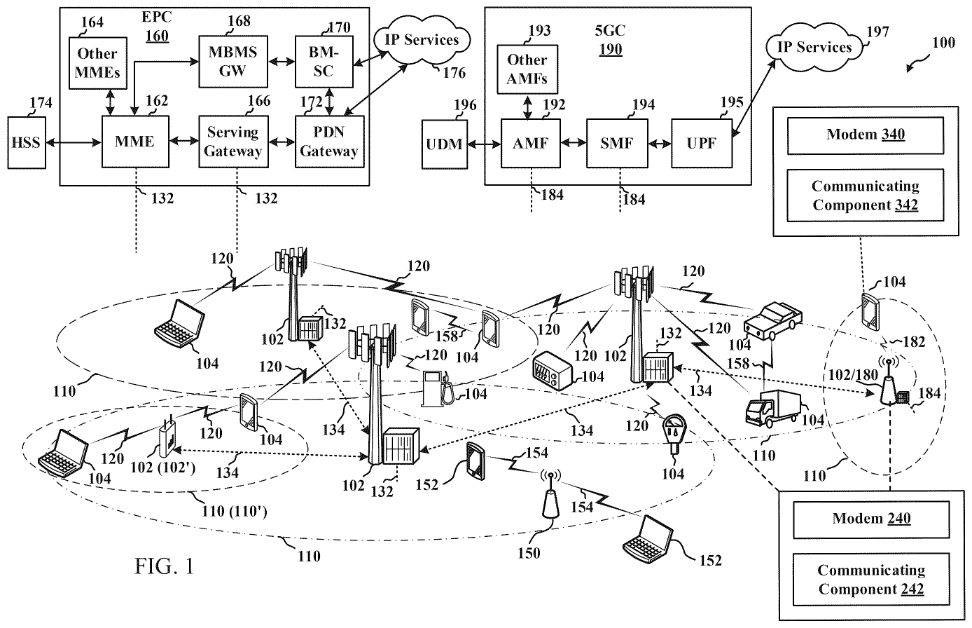

The described features will be presented in more detail below with reference to FIGS. 1-7.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA 2000 1×, 1×, etc. IS-856 (TIA-856) is commonly referred to as CDMA 2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2 ). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) NR networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102, which may also be referred to as network entities, may include macro cells (high power cellular base station) and/or small cells (low power cellular base station). The macro cells can include base stations. The small cells can include femtocells, picocells, and microcells. In an example, the base stations 102 may also include gNBs 180, as described further herein. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs.

In one example, some nodes such as UE 104 of the wireless communication system may have a modem 340 and communicating component 342 for configuring OD-SIB1 parameters and communicating PRACH resources as WUS to request SIB1 from a base station 102, as described herein. Though a UE 104 is shown as having the modem 340 and communicating component 342, this is one illustrative example, and substantially any node or type of node may include a modem 340 and communicating component 342 for providing corresponding functionalities described herein.

In another example, some nodes and/or network entities such as base station 102/gNB 180, may have a modem 240 and communicating component 242 for generating and transmitting, to the UE 104, communication on a downlink channel such as a CSI request field, as described herein.

Though a base station 102/gNB 180 is shown as having the modem 240 and communicating component 242, this is one illustrative example, and substantially any node or type of node may include a modem 240 and communicating component 242 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 132, 134 and/or 184 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a AMF 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). Further, some of the UEs 104 may be referred to or otherwise correspond to AIoT devices IoT UEs may include MTC/enhanced MTC (eMTC, also referred to as CAT-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. One or both of the UE 104 or the base station 102 may corresponds to a reader device capable of or otherwise configured to communicate with one or more AIoT devices according to the present signaling architecture implementations described herein. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

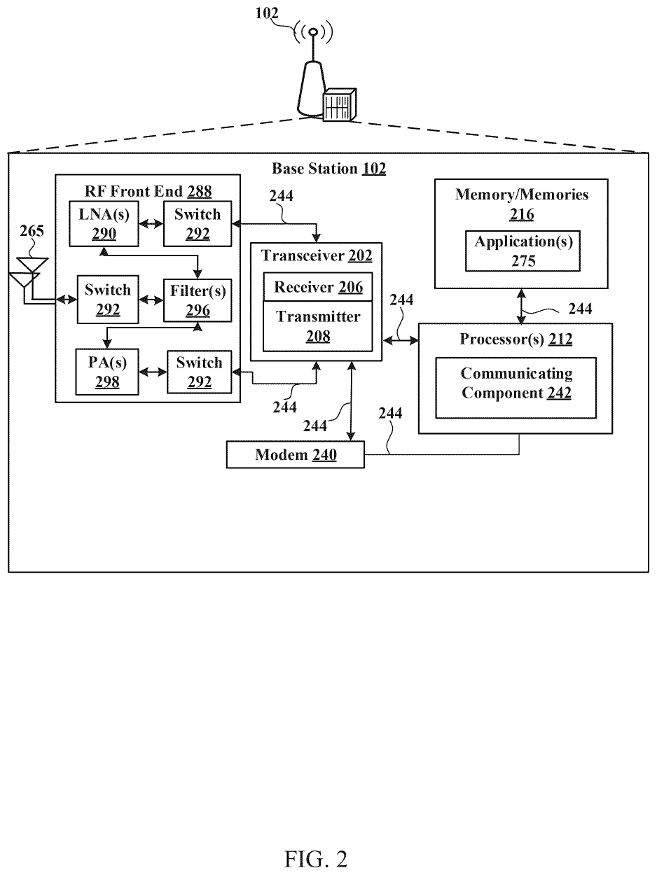

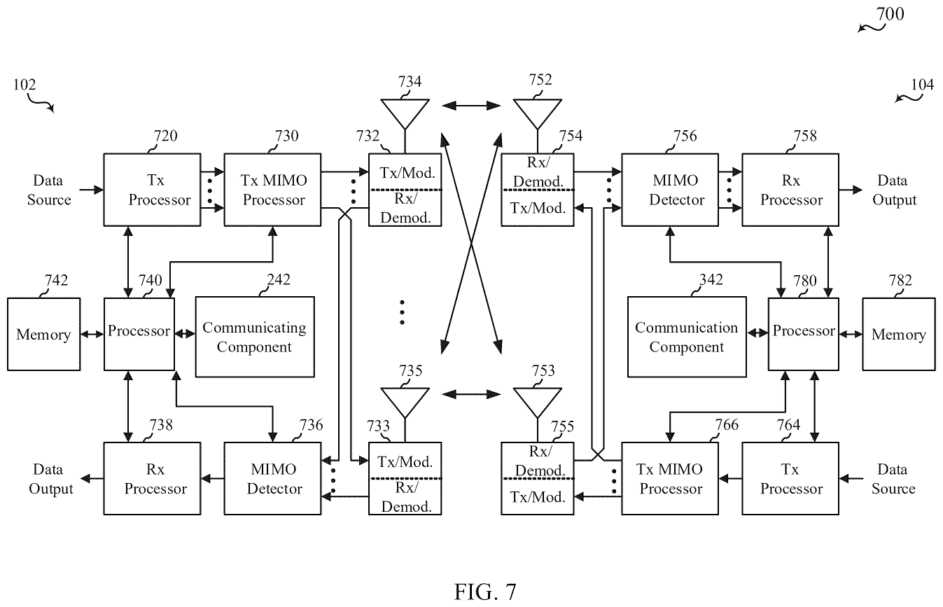

Turning now to FIGS. 2-7, aspects are depicted with reference to one or more components and one or more methods that may perform the actions or operations described herein, where aspects in dashed line may be optional. Although the operations described below in FIG. 7 is presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

Referring to FIG. 2, one example of an implementation of a node or network device, such as the base station 102 (e.g., a base station 102 and/or gNB 180, as described above) may include a variety of components, some of which have already been described above and are described further herein, including components such as one or more processors 212 and memory 216 and transceiver 202 in communication via one or more buses 244, which may operate in conjunction with modem 240 and/or communicating component 242 for transmitting a SIB1 upon request from a UE 104.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when base station 102 is operating at least one processor 212 to execute communicating component 242 and/or one or more of its subcomponents.

Transceiver 202 may include at least one receiver 206 and at least one transmitter 208. Receiver 206 may include hardware and/or software executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware and/or software executable by a processor for transmitting data, the code comprising instructions and being stored in a memory (e.g., computer-readable medium). A suitable example of transmitter 208 may including, but is not limited to, an RF transmitter.

Moreover, in an aspect, base station 102 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals. The antennas 265 may include one or more antennas, antenna elements, and/or antenna arrays.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, the processor(s) 212 may correspond to one or more of the processors described in connection with the UE in FIG. 10. Similarly, the memory 216 may correspond to the memory described in connection with the UE in FIG. 10.

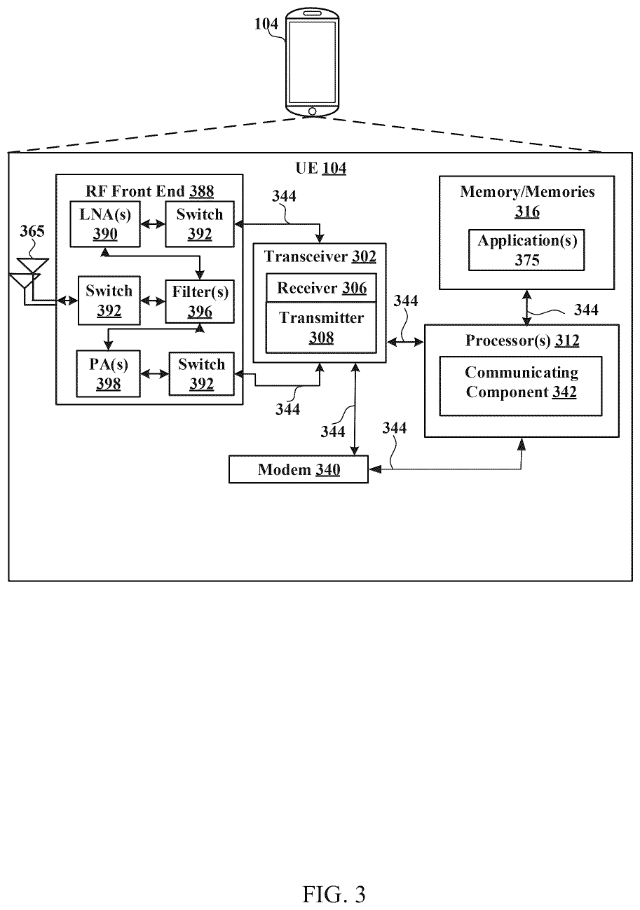

Referring to FIG. 3, one example of an implementation of UE 104. The UE 104 may include a variety of components, some of which have already been described above and are described further herein, including components such as one or more processors 312 and memory 316 and transceiver 302 in communication via one or more buses 344, which may operate in conjunction with modem 340 and/or communicating component 342 for configuring OD-SIB1 parameters and communicating PRACH resources as WUS to request a SIB1.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of base station 102, as described above, but configured or otherwise programmed for base station operations as opposed to base station operations.

In an aspect, the processor(s) 312 may correspond to one or more of the processors described in connection with the base station in FIG. 10. Similarly, the memory 316 may correspond to the memory described in connection with the base station in FIG. 10.

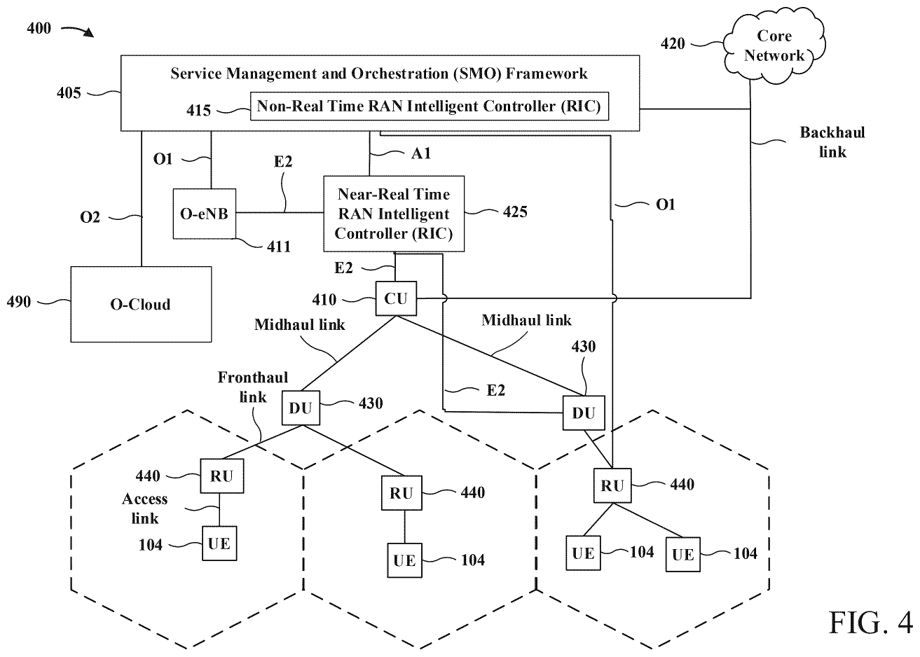

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 2105, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440 and may configure OD-SIB1 parameters and communicating PRACH resources as WUS to request SIB1 from a base station 102.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 2105 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

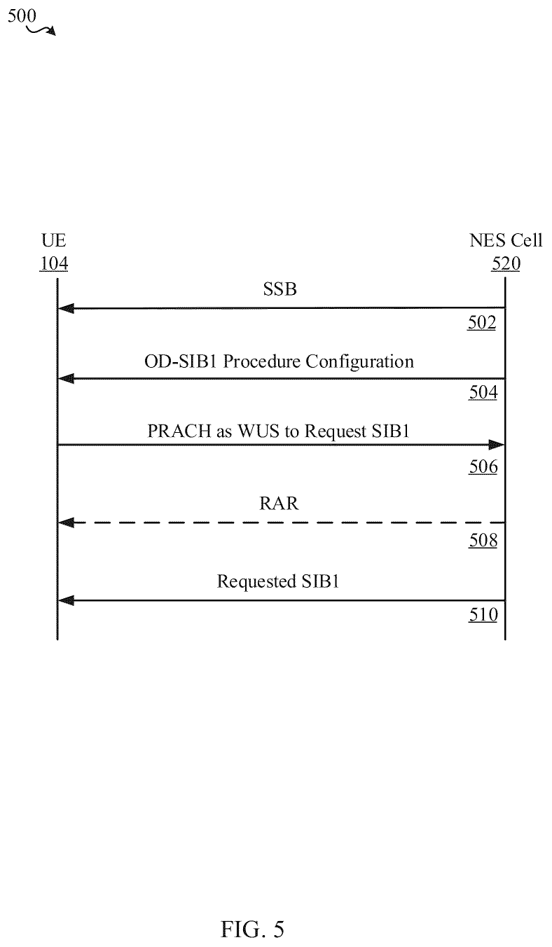

FIG. 5 is a conceptual diagram of an OD-SIB1 procedure 500. At 502, the UE 104 may receive an SSB from a NES cell 520. At 504, the UE 104 may receive an OD-SIB1 procedure configuration information from the NES cell 520. At 506, the UE 104 may transmit a PRACH or a WUS to request SIB1 from the NES cell 520. At 508, the NES cell 520 may transmit a random access response (RAR) to the UE 104. At 510, the UE 104 may receive the requested SIB1 by monitoring PDCCH to receive DCI and receiving the PDSCH carrying the requested SIB1 according to the DCI from the NES cell 520.

The present implementations set forth optimizations related to the configuration, signaling, and power control mechanisms for OD-SIB1 in wireless communication systems. Specifically, the present aspects include methods to enhance the efficiency and flexibility of signaling procedures, uplink WUS configurations, and power control for idle/inactive UEs. Such techniques may reduce signaling overhead, improve resource utilization, and eliminate dependencies between cells for OD-SIB1 transmission, thereby enabling more scalable and autonomous network deployments for next generation wireless technologies.

In an aspect, a process for OD-SIB1 configurations, uplink WUS configurations and communications for idle or inactive UEs may include a first cell periodically transmitting SIB1 and a NES cell. The procedure may involve a UE obtaining an uplink WUS configuration from the first cell, followed by the UE transmitting the WUS to the NES Cell. The NES Cell may then provide the requested OD-SIB1 to the UE, with the triggering mechanism relying on the WUS using PRACH. Additionally, inter-node signaling may be specified within the next-generation radio access network (NG-RAN) nodes to facilitate the WUS configuration, without modifications to the SSB.

Notably, the reliance on the first cell for the WUS configuration introduces deployment constraints, as NES cells may not independently support OD-SIB1 for idle/inactive UEs. For some networks, this dependency may be a target for elimination by enabling NES cells to autonomously provide their own WUS configurations, thereby enhancing scalability and reducing reliance on auxiliary cells. The OD-SIB1 configuration at least includes configuration for the UEs to transmit the signal to request SIB1 and receive the requested SIB1. For example, the configuration may include an uplink/downlink slot structure, frame structure, SSB configuration (such as the transmitted SSBs, transmit power), PRACH configuration, uplink frequency information and PDCCH monitoring configuration for receiving SIB1. Such configuration typically needs hundreds of bits; making it infeasible to be included in MIB.

In an aspect, signaling mechanisms such as MIB/physical broadcast channel (PBCH), downlink control information (DCI)/physical downlink control channel (PDCCH) that can be frequency-division multiplexed with the synchronization signal block (SSB), and physical downlink shared channel (PDSCH) may be referenced for uplink WUS configuration. The present disclosure provides an optimization of signaling parameters related to SSB for uplink WUS transmission, enabling signaling overhead reduction so that the WUS or OD-SIB1 configuration can be included in the MIB.

The present implementations may further include signaling mechanisms for transmitted SSBs within a burst to optimize mapping for WUS resources, enabling OD-SIB1 in advanced networks. In some wireless networks, bitmap configurations may be categorized into a full bitmap (e.g., up to 64 bits) and a compact bitmap (e.g., 16 bits) to reduce signaling overhead, particularly for higher frequency bands like FR2. For some implementations, where WUS configurations may be included in the MIB, the compact bitmap may introduce significant overhead, prompting alternatives to streamline SSB transmission indications.

In a first implementation, a number of techniques may be used to indicate SSB transmission in a SSB burst for PRACH occasion/resource validation, mapping between SSB and the PRACH occasion, and uplink WUS transmission. A first technique involves the signaling of a compact bitmap including inOneGroup and groupPresence indications, which might incur high MIB overhead. A second technique involves the signaling of a groupPresence indication, where the UE may determine that all SSBs in the groups with transmitted SSBs are transmitted. Additionally, the number of bits for groupPresence may be small to efficiently include in the MIB. For example, the number of bits may be set to four to match shortBitmap in the full bitmap. A third technique involves the UE determining that all SSBs may be transmitted (i.e., zero MIB overhead but may lead to wasteful PRACH resources linked to not-transmitted SSBs). A finer SSB indication bitmap for PRACH resource mapping, PDCCH monitoring, PDSCH rate matching and collision handling between SSB and other uplink/downlink channels may be provided in SIB1/RRC.

The present disclosure further includes mechanisms to configure and signal SSB periodicity (also known as SSB burst periodicity) for PRACH occasion validation in wireless communication networks. PRACH occasion may be an allocation of resources in time and frequency domain for PRACH transmission. In some aspects, PRACH occasion and WUS occasion interchangeably in the application since the signal to request SIB1 can be PRACH or UL WUS. The UE may determine a PRACH occasion is valid if the occasion precedes a SS/PBCH block in the PRACH slot and does not start at least N_{gap} symbols after a last SS/PBCH block reception symbol where N_{gap} is predefined.

In some wireless networks, a UE may determine an SSB transmission periodicity of 20 ms during initial cell selection, though the network may transmit an SSB at shorter intervals, such as 10 ms, or longer intervals, such as 40 ms. For PRACH transmissions, validation of PRACH occasions may be dependent on the SSB periodicity indicated in SI. Prior to acquiring SI, the information regarding SSB periodicity may be available to facilitate PRACH or WUS transmission.

In a second implementation, a number of techniques may be employed for determining SSB periodicity during PRACH occasion validation for requesting SI. A first technique may involve an SSB periodicity being provided within the MIB. A second technique may involve a UE utilizing a determined SSB periodicity for initial cell selection, such as the 20 ms. A third technique may involve a UE determining an SSB periodicity that differs from an SSB periodicity the UE determined during initial cell selection. For example, the SSB periodicity can be fixed in the specification for the purpose of PRACH/WUS occasion validation. These approaches may optimize signaling efficiency and resource utilization while enabling autonomous scalability in network deployments.

Further aspects include the association of SSB and PRACH occasions. For example, a UE may be provided a number N of SS/PBCH block indexes associated with one PRACH occasion. In some aspects, the configurable values for N may correspond to ⅛, ¼, ½, 1, 2, 4, 8, or 16. The PRACH time-frequency (T/F) resources may be wasted due to non-transmitted SSBs if N≤1. In particular, the PRACH T/F resources may still be reserved for an SSB that is not transmitted. From a NES perspective, it may be beneficial to keep the PRACH T/F resources for transmitted SSBs within a smaller number of PRACH configuration periods. Hence, it may be beneficial to support N>1.

For instance, for FR1 with up to 8 SSBs, all SSBs can be mapped to a single PRACH occasion. In another example, for FR2 with up to 64 SSBs, N may correspond to 16, and hence would result in 4 RO occasions to cover 64 SSBs. In some aspects, the association of SSB to RO may be differentiated by the preamble index. In this aspect, the value N for association of SSB and PRACH occasion may be fixed. For example, when N>1, the association of SSB to RO may be differentiated by the preamble index. The value can be different for different frequency ranges or for different bands.

Aspects of the present disclosure include power control mechanisms for WUS transmission in wireless networks, focusing on parameters such as ss-PBCH-BlockPower and preambleReceivedTargetPower. For instance, ss-PBCH-BlockPower may correspond to the average energy per resource element (EPRE) of resource elements carrying secondary synchronization signals in dBm during SSB transmission. Further, preambleReceivedTargetPower may correspond to the target power level at the network receiver side, constrained to multiples of 2 dBm (e.g., −202, −200, −198 dBm). These parameters may guide the determination of transmission power for PRACH and WUS, with ranges spanning −60 dBm to 50 dBm for SSB transmission. However, for WUS transmissions, wide-range indication may be infeasible in the MIB.

A number of implementations for SSB transmission power (ss-PBCH-BlockPower) or the target PRACH receive power (preambleReceivedTargetPower) may be set forth in determining transmission power for WUS. In a first implementation, one value is fixed per frequency band or range (e.g., FR1, FR2, FR3). A second implementation includes specifying a limited set of values (e.g., four or fewer) per frequency band or frequency range with an MIB indicating the applicable value. A third implementation includes jointly tabulating SSB transmission power and PRACH target receiver power, with an MIB indicating the corresponding table row. Actual values may be provided in SI or RRC, enabling a UE to utilize these values when acquiring other SI, such as SIB2/3/4, or reacquiring OD-SI due to updates or physical layer procedures.

Aspects of the present disclosure further include power control mechanisms for WUS and PRACH retransmissions to request OD-SI. The parameter preambleTransMax may correspond to a maximum number of Random Access (RA) preamble transmissions performed before a failure is declared, and powerRampingStep may correspond to one or more power ramping steps for PRACH. While fixing these values may be reasonable, supporting multiple values for power ramping steps can enhance SIB1 acquisition latency. For PRACH/WUS retransmissions, multiple power ramping step values, such as {0, 2} dB, may be configured, with the applicable value determined by the number of failed retransmissions. For example, assuming a greatest retransmission count of eight (8), a UE may apply a 0 dB step for the first four transmissions and switch to a 2 dB step starting from the fifth transmission. This adaptive approach optimizes power control and resource efficiency by aligning the ramp-up step with retransmission failure patterns.

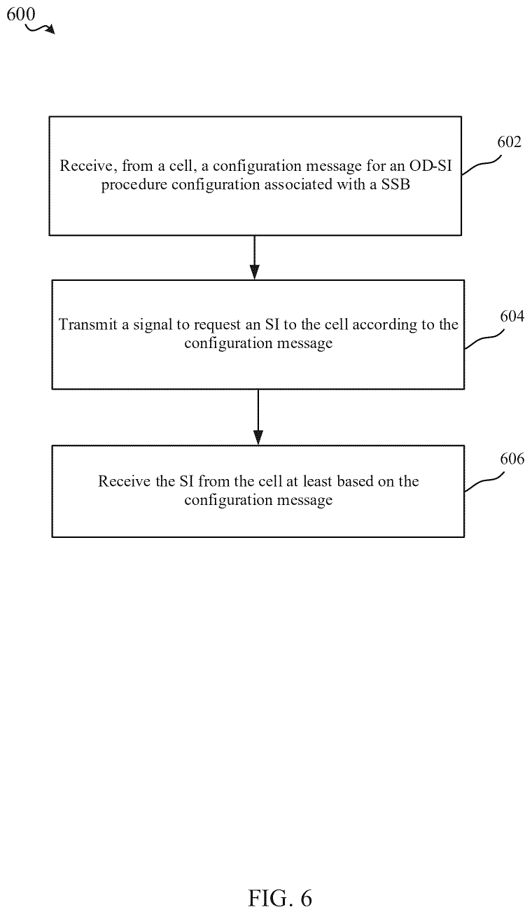

FIG. 6 illustrates a flow chart of an example of a method 600 for wireless communication at a UE, such as the UE 104. In an example, a UE 104 can perform the functions described in method 600 using one or more of the components and techniques described in FIGS. 1, 3-5, and 7, such as via execution of one or more processors, individually or in combination.

At block 602, the method 600 may receive, from a cell, a configuration message for an OD-SI procedure configuration associated with a SSB. In an aspect, the communicating component 342, e.g., in conjunction with processor(s) 312, memory 316, and/or transceiver 302, may be configured to receive, from a cell such as a NES cell, a configuration message for an OD-SI procedure configuration associated with a SSB. Thus, the UE 104, the processor(s) 312, the communicating component 342, or one of its subcomponents may define the means for receiving, from a cell, a configuration message for an OD-SI procedure configuration associated with a SSB. In some aspects, the OD-SI configuration procedure may correspond to OD-SI.

In some implementations, the configuration message may include an SSB burst periodicity.

At block 604, the method 600 may transmit a signal to request an SI to the cell according to the configuration message. In an aspect, the communicating component 342, e.g., in conjunction with processor(s) 312, memory 316, and/or transceiver 302, may be configured to transmit a signal (i.e., PRACH resource) to request an SI (i.e., SIB1) from the cell (i.e., NES cell) according to the configuration message. Thus, the UE 104, the processor(s) 312, the communicating component 342, or one of its subcomponents may define the means for transmitting a signal to request an SI to the cell according to the configuration message.

In some implementations, the signal to request the SI may be a PRACH or an UL-WUS.

In some implementations, the SI may include an SSB transmission indication bitmap for PRACH resource mapping, PDCCH monitoring, and PDSCH rate matching.

At block 606, the method 600 may receive the SI from the cell at least based on the configuration message. In an aspect, the communicating component 342, e.g., in conjunction with processor(s) 312, memory 316, and/or transceiver 302, may be configured to receive the SI from the cell at least based on the configuration message. Thus, the UE 104, the processor(s) 312, the communicating component 342, or one of its subcomponents may define the means for receiving the SI from the cell at least based on the configuration message.

In some implementations, the method 600 may optionally receive a configuration message from the PBCH of the SSB.

In some implementations, the method 600 may optionally receive a bitmap including a first indication indicating a group of one or more SSBs within a SSB burst has at least one SSB that is transmitted and a second indication indicating indices of one or more SSBs within the group that are transmitted.

In some implementations, the method 600 may optionally receive a bitmap including a first indication indicating a group of one or more SSBs within a SSB burst, and all SSBs in the group are transmitted.

In some implementations, the method 600 may optionally identify that all SSBs within the SSB burst are transmitted.

In some implementations, the method 600 may optionally identify a SSB burst periodicity associated with an initial cell selection procedure.

In some implementations, the method 600 may optionally identify an SSB burst periodicity associated with a fixed value.

In some implementations, the method 600 may optionally receive a numerical value representing a number of SSB indexes associated with one resource occasion for transmitting the SI request, and where the numerical value is greater than one and an association of a SSB to the resource occasion is distinguished by a preamble index. Further, the numerical value may be different for distinct frequency ranges or for distinct frequency bands.

In some implementations, the method 600 may optionally identify a transmission power associated with the signal to request the SI, the transmission power corresponding to one of a SSB transmission power or a target receive power for the signal requesting the SI, wherein a value of the transmission power is fixed for each frequency band or for each frequency range. Further, a set of values of the transmission power may be identified for each frequency band or for each frequency range, and where the one or more processors are further configured to receive the configuration message including the set of values.

In some implementations, the method 600 may optionally receive the configuration message including a joint indication of the SSB transmission power and the target receive power for the signal requesting the SI.

In some implementations, the method 600 may optionally retransmit the signal requesting the SI according to one or both of a maximum retransmission attempt value or one or more power ramping step values.

In some implementations, one or more power ramping step values are based on a number of failed transmissions of the signal requesting the SI.

FIG. 7 is a block diagram of a MIMO communication system 700 including a base station 102, which may be acting as a network device, and a UE 104, which may correspond to a reader device. The MIMO communication system 700 may illustrate aspects of the wireless communication access network 100 described with reference to FIG. 1. The base station 102 may be an example of aspects of the base station 102 described with reference to FIG. 1. The base station 102 may be equipped with antennas 734 and 735, and the UE 104 may be equipped with antennas 752 and 753. In the MIMO communication system 700, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 720 may receive data from a data source. The transmit processor 720 may process the data. The transmit processor 720 may also generate control symbols or reference symbols. A transmit MIMO processor 730 may perform spatial processing (e.g., precoding) on data symbols, control symbols, or reference symbols, if applicable, and may provide output symbol streams to the transmit modulator/demodulators 732 and 733. Each modulator/demodulator 732 through 733 may process a respective output symbol stream (e.g., for OFDM, etc.) to obtain an output sample stream. Each modulator/demodulator 732 through 733 may further process (e.g., convert to analog, amplify, filter, and upconvert) the output sample stream to obtain a DL signal. In one example, DL signals from modulator/demodulators 732 and 733 may be transmitted via the antennas 734 and 735, respectively.

The UE 104 may be an example of aspects of the UEs 104 described with reference to FIGS. 1 and 2. At the UE 104, the UE antennas 752 and 753 may receive the DL signals from the base station 102 and may provide the received signals to the modulator/demodulators 754 and 755, respectively. Each modulator/demodulator 754 through 755 may condition (e.g., filter, amplify, downconvert, and digitize) a respective received signal to obtain input samples. Each modulator/demodulator 754 through 755 may further process the input samples (e.g., for OFDM, etc.) to obtain received symbols. A MIMO detector 1056 may obtain received symbols from the modulator/demodulators 754 and 755, perform MIMO detection on the received symbols, if applicable, and provide detected symbols. A receive (Rx) processor 758 may process (e.g., demodulate, deinterleave, and decode) the detected symbols, providing decoded data for the UE 104 to a data output, and provide decoded control information to a processor 780, or memory 1082.

The processor 780 may in some cases execute stored instructions to instantiate the communicating component 242 (see e.g., FIGS. 1 and 2) for configuring OD-SI parameters and communicating PRACH as WUS to request SI from a base station 102.

On the uplink (UL), at the UE 104, a transmit processor 764 may receive and process data from a data source. The transmit processor 764 may also generate reference symbols for a reference signal. The symbols from the transmit processor 764 may be precoded by a transmit MIMO processor 766 if applicable, further processed by the modulator/demodulators 754 and 755 (e.g., for SC-FDMA, etc.), and be transmitted to the base station 102 in accordance with the communication parameters received from the base station 102. At the base station 102, the UL signals from the UE 104 may be received by the antennas 734 and 735, processed by the modulator/demodulators 732 and 733, detected by a MIMO detector 736 if applicable, and further processed by a receive processor 738. The receive processor 738 may provide decoded data to a data output and to the processor 740 or memory 742.

The processor 740 may in some cases execute stored instructions to instantiate the communicating component 342 (see e.g., FIGS. 1 and 3) for configuring OD-SI parameters and communicating PRACH as WUS to request SI from a base station 102.

The components of the UE 104 may, individually or collectively, be implemented with one or more ASICs adapted to perform some or all of the applicable functions in hardware. Each of the noted modules may be a means for performing one or more functions related to operation of the MIMO communication system 700. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 700.

### Some Additional Examples

The aspects described herein additionally include one or more of the following aspect examples described in the following numbered clauses.

1. An apparatus for wireless communications, comprising:

a transceiver having a plurality of antennas;

one or more memories; and

one or more processors coupled to at least one of the one or more memories and configured to:
receive, from a cell, a configuration message for an on-demand system information (OD-SI) procedure configuration associated with a synchronization signal block (SSB);
transmit a signal to request an SI to the cell according to the configuration message; and
receive the SI from the cell at least based on the configuration message.

2. The apparatus of clause 1, wherein the one or more processors are further configured to receive a configuration message from a physical broadcast channel (PBCH) of the SSB.

3. The apparatus of clauses 1 and 2, wherein the signal to request the SI is a physical random access channel (PRACH) or an uplink wake-up signal (UL-WUS).

4. The apparatus of clauses 1-3, wherein the one or more processors are further configured to receive a bitmap including a first indication indicating a group of one or more SSBs within a SSB burst has at least one SSB that is transmitted and a second indication indicating indices of one or more SSBs within the group that are transmitted.

5. The apparatus of clauses 1-4, wherein the one or more processors are further configured to receive a bitmap including a first indication indicating a group of one or more SSBs within a SSB burst, and all SSBs in the group are transmitted.

6. The apparatus of clauses 3-5, wherein the one or more processors are further configured to identify that all SSBs within the SSB burst are transmitted.

7. The apparatus of clauses 1-6, wherein the SI includes an SSB transmission indication bitmap for PRACH resource mapping, PDCCH monitoring, and PDSCH rate matching.

8. The apparatus of clauses 1-7, wherein the configuration message includes an SSB burst periodicity.

9. The apparatus of clauses 1-8, wherein the one or more processors are further configured to identify a SSB burst periodicity associated with an initial cell selection procedure.

10. The apparatus of clauses 1-9, wherein the one or more processors are further configured to identify an SSB burst periodicity associated with a fixed value.

11. The apparatus of clauses 1-10, wherein the one or more processors are further configured to receive a numerical value representing a number of SSB indexes associated with one resource occasion for transmitting the SI request, and wherein the numerical value is greater than one and an association of a SSB to the resource occasion is distinguished by a preamble index.

12. The apparatus of clause 11, wherein the numerical value is different for distinct frequency ranges or for distinct frequency bands.

13. The apparatus of clauses 1-12, wherein the one or more processors are further configured to identify a transmission power associated with the signal to request the SI, the transmission power corresponding to one of a SSB transmission power or a target receive power for the signal requesting the SI.

14. The apparatus of clause 13, wherein a value of the transmission power is fixed for each frequency band or for each frequency range.

15. The apparatus of clauses 13 and 14, wherein a set of values of the transmission power is identified for each frequency band or for each frequency range, and wherein the one or more processors are further configured to receive the configuration message including the set of values.

16. The apparatus of clauses 13-15, wherein the one or more processors are further configured to receive the configuration message including a joint indication of the SSB transmission power and the target receive power for the signal requesting the SI.

17. The apparatus of clauses 1-16, wherein the one or more processors are further configured to retransmit the signal requesting the SI according to one or both of a maximum retransmission attempt value or one or more power ramping step values.

18. The apparatus of clauses 10-17, wherein one or more power ramping step values are based on a number of failed transmissions of the signal requesting the SI.

19. An apparatus for wireless communications, comprising means for performing the steps recited in clauses 1-18.

20. A computer-readable medium comprising stored instructions for wireless communications, wherein the instructions are executable by one or more processors, individually or in combination, to perform the steps recited in clauses 1-18.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communications, comprising:
a transceiver having a plurality of antennas;
one or more memories; and
one or more processors coupled to at least one of the one or more memories and configured to:
receive, from a cell, a configuration message for an on-demand system information (OD-SI) procedure configuration associated with a synchronization signal block (SSB);
transmit a signal to request an SI to the cell according to the configuration message; and
receive the SI from the cell at least based on the configuration message.

2. The apparatus of claim 1, wherein the one or more processors are further configured to receive a configuration message from a physical broadcast channel (PBCH) of the SSB.

3. The apparatus of claim 1, wherein the signal to request the SI is a physical random access channel (PRACH) or an uplink wake-up signal (UL-WUS).

4. The apparatus of claim 1, wherein the one or more processors are further configured to receive a bitmap including a first indication indicating a group of one or more SSBs within a SSB burst has at least one SSB that is transmitted and a second indication indicating indices of one or more SSBs within the group that are transmitted.

5. The apparatus of claim 1, wherein the one or more processors are further configured to receive a bitmap including a first indication indicating a group of one or more SSBs within a SSB burst, and all SSBs in the group are transmitted.

6. The apparatus of claim 3, wherein the one or more processors are further configured to identify that all SSBs within the SSB burst are transmitted.

7. The apparatus of claim 1, wherein the SI includes an SSB transmission indication bitmap for PRACH resource mapping, PDCCH monitoring, and PDSCH rate matching.

8. The apparatus of claim 1, wherein the configuration message includes an SSB burst periodicity.

9. The apparatus of claim 1, wherein the one or more processors are further configured to identify a SSB burst periodicity associated with an initial cell selection procedure.

10. The apparatus of claim 1, wherein the one or more processors are further configured to identify an SSB burst periodicity associated with a fixed value.

11. The apparatus of claim 1, wherein the one or more processors are further configured to receive a numerical value representing a number of SSB indexes associated with one resource occasion for transmitting the SI request, and wherein the numerical value is greater than one and an association of a SSB to the resource occasion is distinguished by a preamble index.

12. The apparatus of claim 11, wherein the numerical value is different for distinct frequency ranges or for distinct frequency bands.

13. The apparatus of claim 1, wherein the one or more processors are further configured to identify a transmission power associated with the signal to request the SI, the transmission power corresponding to one of a SSB transmission power or a target receive power for the signal requesting the SI.

14. The apparatus of claim 13, wherein a value of the transmission power is fixed for each frequency band or for each frequency range.

15. The apparatus of claim 13, wherein a set of values of the transmission power is identified for each frequency band or for each frequency range, and wherein the one or more processors are further configured to receive the configuration message including the set of values.

16. The apparatus of claim 13, wherein the one or more processors are further configured to receive the configuration message including a joint indication of the SSB transmission power and the target receive power for the signal requesting the SI.

17. The apparatus of claim 1, wherein the one or more processors are further configured to retransmit the signal requesting the SI according to one or both of a maximum retransmission attempt value or one or more power ramping step values.

18. The apparatus of claim 1, wherein one or more power ramping step values are based on a number of failed transmissions of the signal requesting the SI.

19. A method of communications, comprising:
receiving, from a cell, a configuration message for an on-demand system information (OD-SI) procedure configuration associated with a synchronization signal block (SSB);
transmitting a signal to request an SI to the cell according to the configuration message; and
receiving the SI from the cell at least based on the configuration message.

20. An apparatus for communications, comprising:
means for receiving, from a cell, a configuration message for an on-demand system information (OD-SI) procedure configuration associated with a synchronization signal block (SSB);
means for transmitting a signal to request an SI to the cell according to the configuration message; and
means for receiving the SI from the cell at least based on the configuration message.
